(19) United States
(12) Patent Application Publication
(10) Pub. No.: US 2008/0142614 A1
(43) Pub. Date: Jun. 19, 2008

(54) Zone Pressure Management System and Method for an Irrigation System

(76) Inventor: Aly Elezaby, Tucson, AZ (US)

Correspondence Address: FITCH EVEN TABIN AND FLANNERY, 120 SOUTH LA SALLE STREET, SUITE 1600, CHICAGO, IL, 60603-3406, US

(21) Appl. No.: 11/611,422

(22) Filed: Dec. 15, 2006

(51) Int. Cl. A01G 27/00; G05D 7/00

(52) U.S. Cl. 239/69; 700/284

(57) ABSTRACT

A zone pressure management system and method are provided for use in an irrigation system having at least one irrigation controller for operating multiple irrigation zones each including multiple irrigation devices or heads, wherein a water supply pump is variably controlled to deliver water to each irrigation zone at an individually preset pressure selected to meet zone pressure requirements while minimizing pump energy requirements. The irrigation controller operates a plurality of solenoid control valves or the like associated respectively with the multiple irrigation zones, and is adapted to open these valves typically in a timed sequence for water flow from the pump to the associated irrigation zones. A zone pressure management unit or module monitors the irrigation controller to determine which irrigation zone is in an “on” state, and signals a pump controller for operating the pump to produce a unique and programmably set output pressure for that irrigation zone.

### BACKGROUND OF THE INVENTION

This invention relates generally to improvements in control systems and methods for use in an irrigation system of the type having a water supply pump for delivering water under pressure to a plurality of irrigation zones each including multiple irrigation devices or heads for distributing irrigation water to a prescribed terrain area. More particularly, this invention relates to a zone pressure management system and method wherein the water supply pump controller is variably commanded to cause the water supply pump to produce a programmably set output pressure selected to meet individual zone pressure requirements while minimizing pump energy consumption.

Irrigation systems commonly include a plurality of irrigation zones each including one or more control valves such as solenoid valves or the like coupled to a source of water under pressure, and each adapted for “on”-“off” operation to supply the water under pressure to an associated plurality of irrigation devices or heads, such as drip irrigation devices, pop-up or stationary spray heads or nozzles, rotor-driven spray heads or nozzles, etc. Each irrigation zone may comprise one or more sections, controlled by one or more valves, all assigned to the same station of an irrigation controller. A programmable irrigation controller is normally coupled to a plurality of such control valves and includes means for turning the valves “on” and “off” typically in a timed sequence for regulating the delivery of the irrigation water to each irrigation zone. Multiple irrigation controllers each associated with multiple zone control valves and related irrigation zones are often included in a single, integrated irrigation system. In many irrigation systems particularly of the type used in agricultural, landscaping or golf course applications and the like, a pump station including a water supply pump is provided for delivering water under pressure from a suitable water source or supply such as a pond, lake or pipeline having a pressure booster device.

The water pressure requirement for each individual irrigation zone is a function of the number and type of irrigation devices or heads included therein, together with other factors such as variations in terrain elevation and water conduit friction losses. In this regard, it is desirable to provide water under pressure to each irrigation zone at a pressure level that meets or exceeds the pressure requirement for that irrigation zone in order to insure adequate and proper irrigation of the terrain and vegetation associated therewith. By contrast, supply of water at an insufficient pressure level may result in inadequate or improper irrigation of the associated vegetation. For any given irrigation system, and despite efforts of irrigation system designers to provide multiple irrigation zones having similar water pressure requirements, the actual pressure requirements for multiple irrigation zones can and will vary significantly.

In the past, constant speed pumps have been used for delivering the irrigation water under pressure to the multiple irrigation zones of a controller-operated irrigation system. Such constant speed pumps inherently produce an output pressure that is an inverse function of water flow rate. In this regard, to insure adequate water pressure for all irrigation zones, the constant speed pump is normally sized to provide the required water output pressure for the particular zone requiring the maximum water flow rate. For other irrigation zones having a lower flow rate requirement, the constant speed pump thereby produces an output pressure that exceeds the pressure requirements for such zones. In some system designs, such low-flow zones include pressure reducers or pressure regulators to relieve excess pressure and thereby prevent undesired or erratic irrigation performance attributable to excess pressure. However, for all such low-flow zones, the constant speed pump produces excess output pressure that is unused or undesirable, and thereby fails to optimize pump energy consumption.

More recently, variable speed pumps have been developed for producing a substantially constant output pressure notwithstanding changes in water flow rate as the irrigation controller shifts the pump output through a succession of irrigation zones having different water flow requirements. Such variable speed pumps incorporate means for changing speed by varying the frequency of a pump drive signal, whereby such pumps are commonly referred to as variable frequency drive (VFD) pumps. In a multi-zone irrigation system, pump drive speed is normally regulated to provide a constant output pressure selected to match the maximum pressure level required by the multiple zones. Unfortunately, for all other zones having lower and different individual pressure requirements, the VFD pump produces excess output pressure and thereby fails to optimize pump energy consumption.

The present invention provides an improved pressure management and control system for use in an irrigation system having multiple irrigation zones, wherein the output pressure produced by a VFD pump is individually and variably adjusted in accordance to the unique and pre-programmed pressure requirements of each individual irrigation zone, whereby generation of excess pump output pressure is avoided and pump energy consumption is optimized.

### SUMMARY OF THE INVENTION

In accordance with the invention, a pressure management system and method are provided for use in a multi-zone irrigation system to variably control the output pressure of a water supply pump in accordance with the individual water pressure requirements of the multiple irrigation zones, thereby minimizing pump energy requirements.

The irrigation system includes at least one irrigation controller for operating multiple irrigation zones each including a control valve such as a solenoid valve for controlling water flow to an associated plurality of irrigation devices or heads. The irrigation controller turns these control valves “on” and “off.” The controller may be operated in a sequence for connecting each irrigation zone to a flow of irrigation water under pressure from the pump. By way of examples, the sequence may be determined by a set of fixed time intervals or by detection of soil moisture conditions. A zone pressure management unit or module monitors the irrigation controller and/or the associated control valves to identify which specific zone or zones are turned “on”, and responds by signaling a pump controller to vary the water supply output pressure according to the unique and programmably preset pressure requirements of that irrigation zone or zones. Normally, the pump controller will be signaled to provide sufficient pressure to satisfy the needs of the irrigation zone with the highest pressure demand of those that are turned “on.”

The zone pressure management or module, in one preferred form, is adapted for programmed input of a predetermined pressure level associated with each one of the multiple irrigation zones. The water supply pump comprises, in the preferred form, a variable frequency drive (VFD) pump operated at variable frequency by a pump controller to produce a water supply at a variably selected output pressure. The zone pressure management module signals the pump controller for operating the pump in a manner producing an output pressure corresponding with the predetermined pressure requirement associated with the specific operational irrigation zone. In this manner, the pump generates sufficient output pressure for substantially optimized operation of each irrigation zone, but substantially without generating excess pressure and thereby desirably minimizing pump power consumption.

Other features and advantages of the present invention will become more apparent from the following detailed description taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is a schematic diagram illustrating an irrigation controller for operating a multi-zone irrigation system, and further incorporating the zone pressure management system and method of the present invention;

FIG. 2 is an enlarged and somewhat diagrammatic front elevation view of a zone pressure management unit or module in accordance with one preferred form of the invention;

FIG. 3 is a schematic diagram similar to a portion of FIG. 1, but depicting further system and method details in accordance with one preferred form of the invention;

FIG. 4 is a graph depicting the operation of the zone pressure management system and method for variably regulating output pressure from a water supply pump in accordance with a sequence of operations of a plurality of irrigation system zones coupled thereto; and

FIG. 5 is a schematic diagram illustrating one alternative preferred form of the invention.

### DETAILED DESCRIPTION OF THE PREFERRED EMBODIMENT

As shown in the exemplary drawings, a zone pressure management system and related method are provided for use in an irrigation system of the type having a pump 10 for delivering a supply of water under pressure to a plurality of irrigation zones 12 each including a control valve 14 for coupling the water flow to an associated plurality of irrigation devices or heads 16. The zone pressure management system and method monitors one or more irrigation controllers 24 and/or the zone control valves 14 to determine which irrigation zone or zones 12 is in an “on” state, i.e., to determine which control valve or valves 14 is in an on condition for water flow to the associated irrigation devices or heads 16, and responds thereto for variably controlling the pump 10 to produce a predetermined or preprogrammed output pressure that substantially meets the pressure requirements for that particular irrigation zone 12. Accordingly, the pump 10 is regulated to produce a uniquely selected output pressure for each one of the multiple irrigation zones to achieve substantially optimized irrigation performance. By contrast, generation of excess pressure for any one of the multiple irrigation zones 12 is substantially avoided, whereby pump power consumption is substantially minimized.

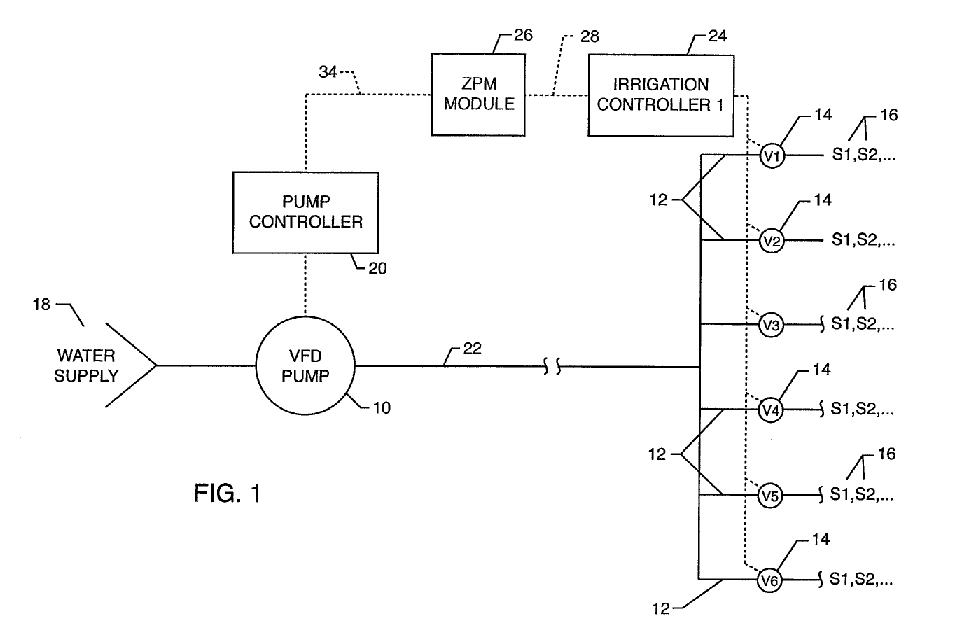

FIG. 1 shows an exemplary irrigation system having the pump 10 suitably positioned at a pump station and adapted to draw water from a source or supply 18, such as a pipeline to a lake or pond in a typical pump-driven irrigation system used in an agricultural, landscaping or golf course or similar irrigation system application. The pump 10, in accordance with one aspect of the invention, comprises a variable speed drive (VFD) pump having a pump controller 20 for providing a variable frequency drive signal to operate the pump 10 at a selected regulated speed. In operation, the pump 10 delivers the irrigation water through a supply conduit 22 at a selected output pressure for flow to the multiple irrigation zones 12. The particular output pressure of this water supply is a function of pump drive speed, and thus is variably regulated by the pump controller 20.

The multiple irrigation zones 12 include parallel conduit networks each having an upstream end coupled to the water supply conduit 22, and a control valve 14 such as a solenoid valve mounted generally at said upstream end for on-off operation to respectively permit or prevent flow of water under pressure to the associated plurality of irrigation devices or heads 16. FIG. 1 shows an illustrative system have a total of six parallel irrigation zones 12 having control valves 14 identified as V1 through V6 for respectively controlling flow of the pressurized water supply to an associated plurality of irrigation devices or heads 16 identified as S1, S2, . . . . Persons skilled in the art will recognize and appreciate that the number of irrigation zones 12 may vary, and further that the number and type of particular irrigation devices or heads 16 may also differ. For example, the irrigation devices or heads 16 may comprise emitter units, pop-up or stationary spray heads, rotor-driven heads, or other types of irrigation devices.

The zone control valves 14 are coupled to an irrigation controller 24 of a type known in the art for turning the valves “on” and “off” in a regulated sequence or manner, thereby controlling the supply of irrigation water to each irrigation zone 12. In this regard, the irrigation controller 14 may be preprogrammed for turning the zone control valves 14 “on” at preselected times and for preselected time intervals to supply irrigation water to each zone 12 for irrigating a prescribed terrain area and/or vegetation associated therewith. For example, in a typical irrigation controller 24, the multiple irrigation zones 12 will be operated in sequence by turning “on” the control valve V1 associated with the first zone for a preset time interval, followed by turning “off” said valve V1 and turning “on” the control valve V2 associated with the second zone for another preset time interval, and so on until each of the control valves 14 is actuated to permit flow of the pressurized water supply to the associated zone 12. Alternatively, the irrigation controller 14 may receive information about soil conditions, such as moisture content, and may turn the zone control valves 14 “on” in response to certain soil conditions. Those skilled in the art will recognize a variety of criteria for controlling the watering schedule for the zones 12.

The zone pressure management system and method of the present invention provides a communication link between the irrigation controller 24 and the pump controller 20, so that the pump 10 can be variably controlled according to the specific zone control valve 14 that is turned “on” to supply water at an output pressure that is uniquely selected to meet or match the pressure requirements of the particular irrigation zone 12 associated with the “on” control valve 14. As the irrigation controller 24 sequentially operates the control valves 14 in sequence, the pump controller 20 is appropriately signalled to alter pump speed in a manner producing a corresponding sequence of predetermined output pressures chosen to meet or match the individual pressure requirements of each zone 12 of the irrigation system. As a result, the pump 10 generates sufficient output pressure for proper operation of the irrigation devices or head 16 of each zone 12, substantially without generating excess pressure and at any time, and thereby substantially minimizing overall pump energy consumption.

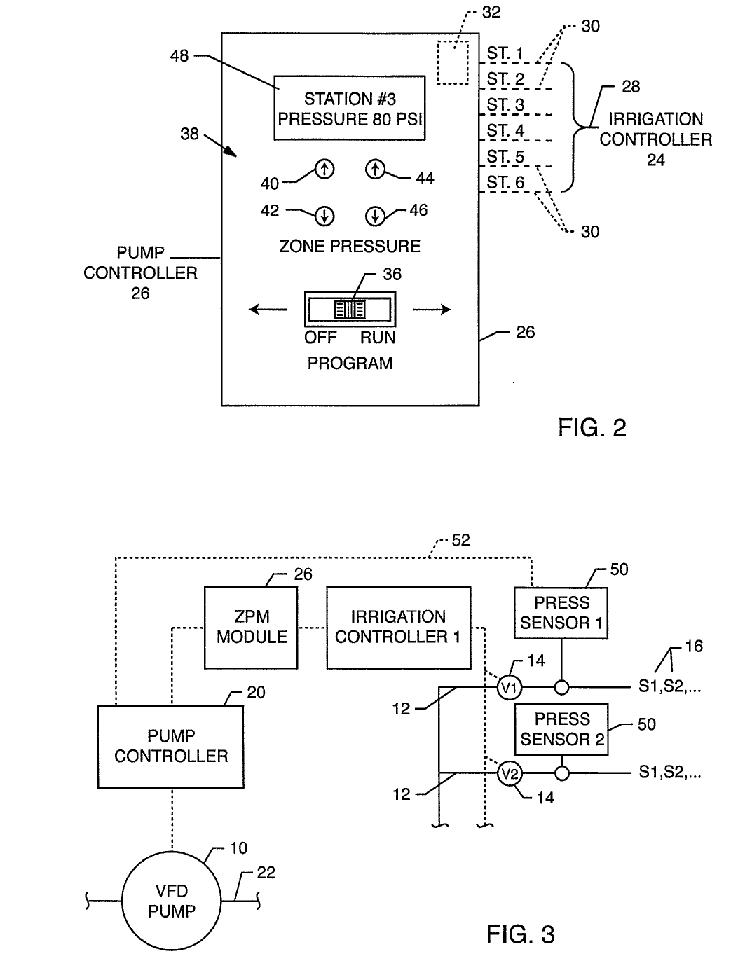

FIG. 1 shows the zone pressure management system in the form of a zone pressure management unit or module 26 coupled between the irrigation controller 24 and the pump controller 20. A cable 28 (FIG. 1) preferably includes a plurality of parallel conductors 30 (FIG. 2) coupled between the module 26 and the irrigation controller 24, wherein each of the multiple conductors 30 is associated with a respective one of the zone control valves 14. Accordingly, these conductors 30 enable the module 26 to monitor the on-off states of the zone control valves 14, and thereby determine which valve 14 is in an “on” state. Alternatively, wireless communication may be used to convey information about the states of the control valves 14 to the module 26. The module 26 further incorporates a programmable memory 32 for receiving and storing an individually selected or predetermined pressure level associated with each one of the multiple irrigation zones 12, and is adapted to signal the pump controller 20 via a control line 34 to operate the pump 10 in a manner providing the individually predetermined output pressure level to each zone 12 when the associated zone control valve 14 is turned “on”.

As shown best in FIG. 2, the zone pressure management unit or module 26 in one preferred form includes a main control switch 36 for setting the state of unit operation, such as a slide switch movable between “run”, “program”, and “off” positions as shown. In the “program” position, a keypad 38 including a pair of “zone” buttons 40 and 42 and a pair of “pressure” buttons 44 and 46 can be manipulated for increasing or decreasing the selected zone number and a programmed pressure level, both as indicated on a display panel 48 such as an LCD display or the like. These “zone” buttons 40, 42 can thus be manipulated to select a specific one of the multiple irrigation zones 12, whereupon the “pressure” buttons 44, 46 can be manipulated to select a specific pressure corresponding with the pressure requirements for that particular zone. A specific pressure level can be programmed in this manner for each of the irrigation zones 12, after which the control switch 36 can be shifted to the “run” position.

Thereafter, in operation, as the irrigation controller 24 turns “on” each of the zone control valves 14 in sequence, in parallel, or in overlapping relation, the zone pressure management module 26 monitors the irrigation controller 24 or the irrigation valves 14 and determines which of the irrigation zones 12 is operational by determining which of the control valves 14 is in an “on” state, and responds by generating a control signal coupled to the pump controller 20 to variably regulate the drive speed of the pump 10 in a manner to provide an output pressure corresponding with the selected or programmed pressure level for that zone or corresponding with the highest programmed pressure level for multiple zones operating at the same time. As an example, the control signal can be used to designate a percentage of a predetermined baseline pressure for the pump 10. For example, in a system that is operating at 120, 60 and 40 psi, the baseline pressure for the pump would be 120 psi. The zone pressure management module 26 may send a signal from a scale of 0 to 10, with 10 designating the baseline pressure of 120 psi, 9 designating 90% of the baseline pressure, i.e., 108 psi, and so forth. Those skilled in the art will readily recognize that other encoding schemes for the control signal may be used.

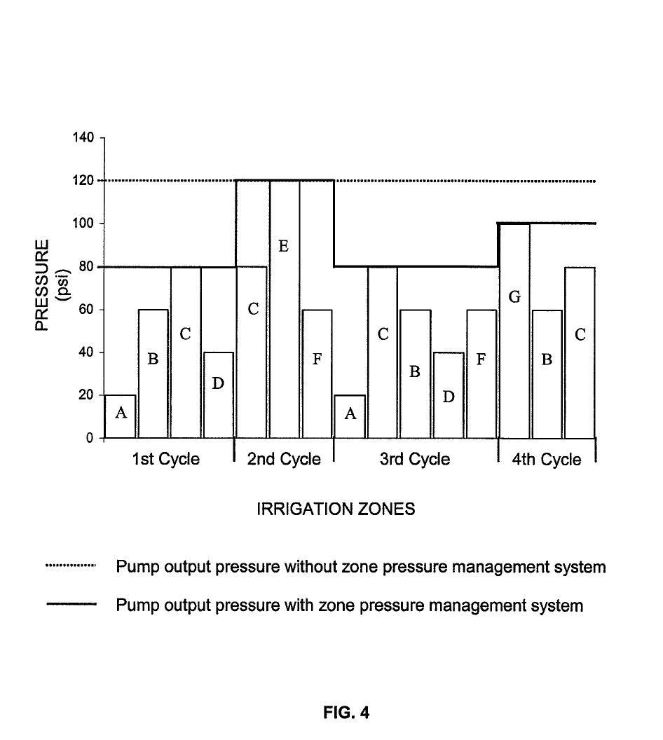

Table 1 below provides an example of how the zone pressure management system operates in principle. The table illustrates a hypothetical sequence of four watering cycles. During the first cycle, four irrigation zones, A through D, are in the “on” state. Zone C has the highest demand of the four zones and so the zone pressure management system generates a control signal to the pump controller 20 to regulate the pump 10 to provide an output pressure of 80 psi, corresponding to the demand of zone C. During the second cycle, three irrigation zones, C, E and F, are in the “on” state. Zone E has the highest demand of the three active zones, and thus, the pump output pressure will be set to the demand of zone E. Note that without the zone pressure management system, the output pressure of the pump would always be 120 psi, regardless of the demands of the irrigation zones that are in the “on” state at any given time. FIG. 4 provides a graph of the example of Table 1.

TABLE 1

| | | | | VFD Pump |
|---|---|---|---|---|
| | | Demand | Pump Output | Output (psi) |
| Cycle | Zones | (psi) | (psi) with ZPM | without ZPM |
| 1 | A | 20 | 80 | 120 |
| | B | 60 | | |
| | C | 80 | | |
| | D | 40 | | |
| 2 | C | 80 | 120 | |
| | E | 120 | | |
| | F | 60 | | |
| 3 | A | 20 | 80 | |
| | C | 80 | | |
| | B | 60 | | |
| | D | 40 | | |
| | F | 60 | | |
| 4 | G | 100 | 100 | |
| | B | 60 | | |
| | C | 80 | | |

Each irrigation zone 12 may additionally include a pressure sensor 50 (FIG. 3) disposed downstream from the associated control valve 14 for monitoring the actual water pressure supplied to that zone, and for providing a feedback signal on a feedback line 52 to the pump controller 20 to adjust pump drive speed in a manner to obtain the programmed pressure level for that zone. Alternatively, this pressure feedback signal may be linked to the module 26 which in turn signals the pump controller 20.

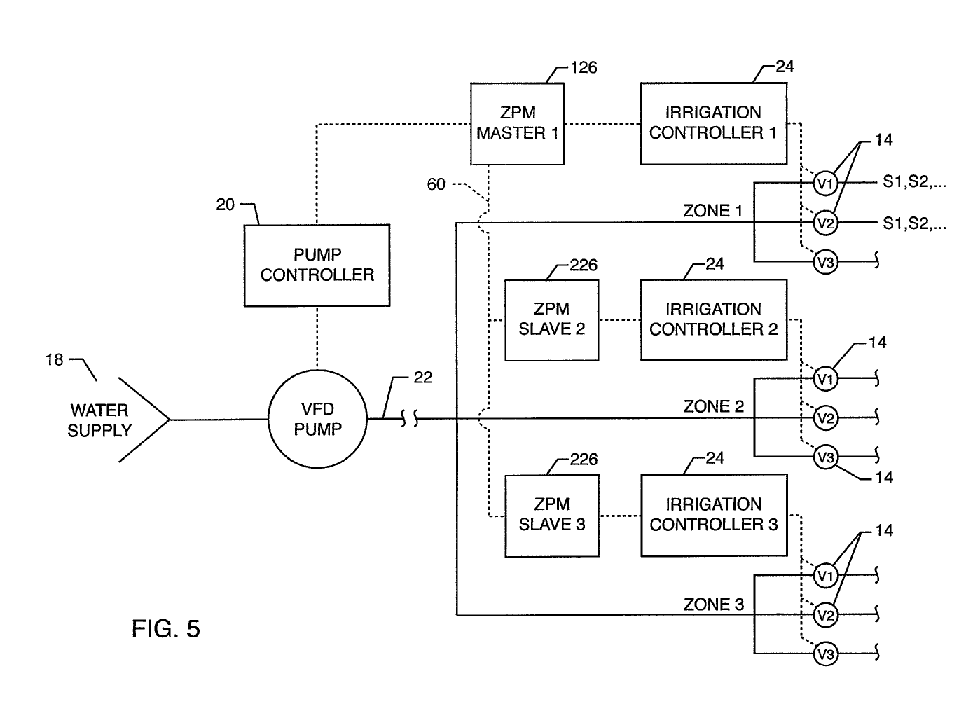

FIG. 5 depicts an alternative preferred form of the invention, wherein the irrigation system includes multiple irrigation controllers 24 each adapted for on-off operation of an associated plurality of control valves 14 associated in turn with a corresponding plurality of irrigation zones 12. In this arrangement of the invention, a plurality of zone pressure management units or modules are associated respectively with each of the irrigation controllers. More particularly, as shown, a first zone pressure management module 126 comprises a “master” unit or module, and the remaining zone pressure management modules 226 comprises “slave” units or modules. In this configuration of the invention, each one of the zone pressure management modules 126 and 226 responds to and operates the associated irrigation controller 24 and related zone control valves 14 in the same manner as previously described herein with respect to FIGS. 1-4. However, the “slave” modules 226 are linked to and communicate with the “master” module 126 as by means of a communication cable 60, a wireless communications system (not shown) or the like, and the “master” module 126 relays a control signal to the pump controller 20 to operate at the highest of the pressures required by all of the operating irrigation zones that are “on” at that time.

While the zone pressure management units or modules are shown and described herein in the form of a separate component coupled between the associated irrigation controllers and the pump controller by means of a hard-wired communication link, persons skilled in the art will recognize and appreciate that alternative forms of the invention may be employed. By way of example, the communication links may be by hard wire, modem, or radio frequency coupling. In addition, the zone pressure management units or modules may by incorporated into the irrigation controller and/or into the pump controller in lieu of providing a discrete or separate system component.

A variety of further modifications and improvements in and to the zone pressure management system and method of the present invention will be apparent to those persons skilled in the art. Accordingly, no limitation on the invention is intended by way of the foregoing description and accompanying drawings, except as set forth in the appended claims.

What is claimed is:

1. A zone pressure management system for use in an irrigation system having a pump for delivering water under pressure to a plurality of irrigation zones each including a zone control valve movable between on and off positions for respectively permitting and preventing water flow thereto, and an irrigation controller for operating the zone control valves, said zone pressure management system comprising:
a programmable zone pressure management module for receiving and storing a plurality of individually selected pressure levels corresponding respectively with each one of the plurality of irrigation zones;
said zone pressure management module including means for monitoring the zone control valves to identify which one or more of the zone control valves is in an on position, and for responding thereto by generating a control signal for controlling the pump to deliver water at an output pressure substantially corresponding with the individually selected pressure levels for the irrigation zones associated with the identified one or more on zone control valves.

2. The zone pressure management system of claim 1 further including a pump controller for variably driving the pump, and wherein said control signal generated by said zone pressure management module is coupled to said pump controller.

3. The zone pressure management system of claim 2 wherein the pump comprises a variable speed drive pump.

4. The zone pressure management system of claim 1 wherein said zone control valve monitoring means comprises a communication link between said zone pressure management module and the irrigation controller.

5. The zone pressure management system of claim 1 wherein said zone pressure management module further includes means for programmably inputting the plurality of individually selected pressure levels corresponding respectively with each one of the plurality of irrigation zones.

6. An irrigation system, comprising:
a pump for delivering water under pressure;
a plurality of irrigation zones coupled to said pump, each of said irrigation zones including a zone control valve movable between on and off positions for respectively permitting and preventing water flow thereto;
an irrigation controller for operating the zone control valves; and
a zone pressure management unit for associating a plurality of individually selected pressure levels corresponding respectively with each one of the plurality of irrigation zones;
said zone pressure management unit further including means for monitoring the zone control valves to identify which one or more zone control valves is in an on position, and for responding thereto by generating a control signal for controlling the pump to deliver water at an output pressure substantially corresponding with the highest of the individually selected pressure levels for the one or more irrigation zones associated with the identified one or more on zone control valves.

7. The irrigation system of claim 1 further including a pump controller for variably driving the pump, and wherein said control signal generated by said zone pressure management unit is coupled to said pump controller.

8. The irrigation system of claim 7 wherein the pump comprises a variable speed drive pump.

9. The irrigation system of claim 6 wherein said zone control valve monitoring means comprises a communication link between said zone pressure management unit and the irrigation controller.

10. The irrigation system of claim 6 further comprising a pressure sensor for detecting the pressure of water delivered by the pump and for providing a feedback signal for controlling the pump to deliver water at a desired output pressure.

11. The irrigation system of claim 6 wherein said zone pressure management unit further includes means for programmably inputting the plurality of individually selected pressure levels corresponding respectively with each one of the plurality of irrigation zones.

12. A zone pressure management method for use in an irrigation system having a pump for delivering water under pressure to a plurality of irrigation zones each including a zone control valve movable between on and off positions for respectively permitting and preventing water flow thereto, and an irrigation controller for operating the zone control valves, said method comprising the steps of:
associating a plurality of individually selected pressure levels corresponding respectively with each one of the plurality of irrigation zones;
identifying which one or more of the zone control valves is in an on position; and
generating a control signal for controlling the pump to deliver water at an output pressure substantially corresponding with the highest of the individually selected pressure levels for the one or more irrigation zones associated with the identified one or more on zone control valves.

13. The method of claim 12 wherein the irrigation system further includes a pump controller for variably driving the pump, and further including the step of coupling the control signal to the pump controller for controlling the pump.

14. The method of claim 13 wherein the pump comprises a variable speed drive pump.

15. The method of claim 12 wherein controlling the pump to deliver water at an output pressure substantially corresponding with the one or more individually selected pressure levels for the irrigation zones associated with the identified one or more on zone control valves comprises:
identifying the largest of the one or more individually selected pressure levels for the irrigation zones associated with the identified one or more on zone control valves; and
generating a control signal for controlling the pump to deliver water at an output pressure substantially corresponding to the identified largest of the one or more individually selected pressure levels.

16. The method of claim 12 wherein said identifying step comprises the step of monitoring the irrigation controller.

17. The method of claim 1 further including the step of monitoring actual water pressure supplied to the associated irrigation zone, and providing a feedback signal for controlling the pump to deliver water at an output pressure substantially corresponding with the individually selected pressure level for the irrigation zone associated with the on zone control valve.
